(19) United States
(12) Patent Application Publication
(10) Pub. No.: US 2020/0114815 A1
(43) Pub. Date: Apr. 16, 2020

(54) ANTI-TAILGATING SYSTEM

(71) Applicants: R. Kemp Massengill, Poway, CA (US); David E. Newman, Palos Verdes, CA (US)

(72) Inventors: R. Kemp Massengill, Poway, CA (US); David E. Newman, Palos Verdes, CA (US)

(21) Appl. No.: 16/360,437

(22) Filed: Mar. 21, 2019

Related U.S. Application Data
(60) Provisional application No. 62/745,866, filed on Oct. 15, 2018.
(60) Provisional application No. 62/771,413, filed on Nov. 26, 2018.
(60) Provisional application No. 62/781,682, filed on Dec. 19, 2018.
(60) Provisional application No. 62/810,193, filed on Feb. 25, 2019.

(51) Int. Cl. B60Q 1/52; B60W 30/16

(52) U.S. Cl. CPC B60Q 1/525; B60W 30/16; B60W 2550/302; B60W 2550/308; B60W 2550/14

(57) ABSTRACT

Systems and methods are disclosed to promote safe defensive driving by maintaining an adequate separation distance between vehicles. In some embodiments, a subject vehicle may include an anti-tailgating system configured to detect a following vehicle, measure the separation distance between vehicles, and activate a distinctive signaling device. A sequence of increasingly urgent distinctive signaling devices may be activated according to a series of predetermined threshold values corresponding to the separation distance, the speed of the subject vehicle, the relative speed of the tailgating vehicle, the condition of the road surface, and others. The distinctive signaling devices may comprise lights with a distinctive color or shape or position, a text message presented upon the rear of the subject vehicle, among many other distinctive signaling options. The anti-tailgating system may save lives by reminding drivers to leave adequate separation distance between vehicles.

### PRIORITY CLAIMS AND RELATED APPLICATIONS

This application claims the benefit of a U.S. Provisional Patent Application No. 62/745,866 entitled “Anti-Tailgating System” and filed on Oct. 15, 2018, and U.S. Provisional Patent Application No. 62/771,413 entitled “Anti-Tailgating System” and filed on Nov. 26, 2018, and U.S. Provisional Patent Application No. 62/781,682 entitled “Anti-Tailgating System” and filed on Dec. 19, 2018, and U.S. Provisional Patent Application No. 62/810,193 entitled “Anti-Tailgating System” and filed on Feb. 25, 2019, the entire disclosures of which are incorporated by reference as part of the specification of this application.

### FIELD OF THE INVENTION

The invention relates to methods and systems for preventing tailgating between vehicles.

### BACKGROUND OF THE INVENTION

A driver of a vehicle traveling too close (a “tailgater”) is a serious safety hazard. Tailgaters are responsible for needless collisions and loss of life. By driving too close to the vehicle in front (the “subject vehicle”), the tailgater is unable to respond to changing conditions, such as a sudden deceleration of the subject vehicle. In addition, the subject vehicle driver may be distracted by the encroaching car from behind, further degrading safety.

What is needed is a system to detect tailgaters and respond in a manner that tends to discourage them from continuing to drive too close.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY OF THE INVENTION

Systems and methods are provided that meet one or more of the needs described above, as well as others. In one implementation, the systems and methods include a distinctive signal or message that unambiguously refers to the tailgating activity, and is not easily confused with any other signals on the subject vehicle.

In one aspect, the invention is directed to an anti-tailgating system to deter tailgating, including a proximity sensor mounted on a subject vehicle and configured to measure the separation distance between the subject vehicle and a tailgating vehicle, one or more signaling devices mounted on the subject vehicle and configured to emit signals observable to a driver of the tailgating vehicle, and a processor configured to compare the separation distance to each of a plurality of predetermined threshold values, and to activate the signaling devices according to which of the predetermined threshold values has been crossed.

In another aspect, the invention is directed to a method for warning of tailgating vehicles comprising sensing with a proximity sensor a separation distance between a subject vehicle and the tailgating vehicle, and operating a processor which is configured to cause one or more signals to be emitted when the separation distance between the subject vehicle and the tailgating vehicle is calculated to be less than a particular value of a plurality of predetermined threshold values, wherein the signals are emitted by one or more signaling devices mounted on the subject vehicle, and wherein the signaling devices are configured to emit the signals in a direction of the tailgating vehicle.

This Summary is provided to introduce a selection of concepts in a simplified form. The concepts are further described in the Detailed Description section. Elements or steps other than those described in this Summary are possible, and no element or step is necessarily required. This Summary is not intended to identify key features or essential features of the claimed subject matter, nor is it intended for use as an aid in determining the scope of the claimed subject matter. The claimed subject matter is not limited to implementations that solve any or all disadvantages noted in any part of this disclosure.

These and other embodiments are described in further detail with reference to the figures and accompanying detailed description as provided below.

### FIGURES

FIG. 1 is a sketch showing an exemplary embodiment of an anti-tailgating system for detecting and responding to tailgaters.

FIG. 2 is a flowchart showing an exemplary method for detecting and responding to tailgaters.

FIG. 3 is a sketch showing an exemplary embodiment of an anti-tailgating system with two rear-facing lights of different colors.

FIG. 4 is a sketch showing an exemplary embodiment of an anti-tailgating system with four rear-facing lights of different colors.

FIG. 5 is a sketch showing an exemplary embodiment of an anti-tailgating system with a rear-facing message.

FIG. 6 is a sketch showing an exemplary embodiment of an anti-tailgating system activating different distinctive signaling devices according to the distance between the tailgater and the subject vehicle.

FIG. 7 is a sketch showing an exemplary embodiment of an anti-tailgating system activating different distinctive signaling devices according to the relative velocity between the tailgater and the subject vehicle.

FIG. 8A is a sketch showing an exemplary embodiment of an anti-tailgating system directing a distinctive signal toward a tailgating driver.

FIG. 8B is a sketch showing another view of an exemplary embodiment of an anti-tailgating system directing a distinctive signal toward a tailgating driver.

FIG. 9 is a sketch showing an exemplary embodiment of a user-installable interior-mounted anti-tailgating system.

FIG. 10 is a sketch showing an exemplary embodiment of a user-installable exterior-mounted anti-tailgating system.

FIG. 11 is a schematic showing how the components of an exemplary embodiment respond to a tailgater event.

Like reference numerals refer to like elements throughout. Elements are not necessarily to scale unless otherwise noted.

### DETAILED DESCRIPTION

Systems to detect and respond to tailgaters in a distinctive and readily recognized way (the “anti-tailgating systems”) are disclosed. An exemplary anti-tailgating system in a subject vehicle may comprise a proximity sensor, one or more distinctive signaling devices, and a processor configured to activate the distinctive signaling devices according to the distance between the subject vehicle and the tailgating vehicle (the “separation distance”). The distinctive signaling devices, and the distinctive warning signal or signals they emit to tailgaters, are “distinctive” when they may be described by parameters that are visibly different from corresponding parameters of all the other lights and signals commonly present at the rear of a vehicle. In one example, two colors are “visibly different” if they can be readily discerned by a non-color-blind person with 20/20 vision at a distance corresponding to a tailgater distance of 10 or 30 or 50 meters. Thus, a distinctive signal is a signal, perceptible to the tailgater, that unambiguously indicates that the tailgater is too close. Moreover, the distinctive signal may be those that cannot be readily confused with other signals such as brake lights, turn signals, running lights, etc. since the distinctive signal may be described by parameters that are different from corresponding parameters of all other signals present at the rear of the subject vehicle. Such parameters may include color, shape, position, or temporal modulation, or the like, that clearly discriminate the distinctive signal relative to all other signals commonly present on the rear of a vehicle. The distinctive signaling device or devices may be configured to direct the distinctive signal or signals only toward the tailgater, and to avoid or minimize or attempt to prevent the distinctive signals from being observable to other drivers.

In some embodiments, the anti-tailgating system may include a camera which may, on command of the processor, record images of the tailgating vehicle and its driver. Information regarding the tailgating event may be recorded in non-transient media along with the images or separately, including the date and time, the measured separation distance versus time, the speed of the subject vehicle and/or the tailgating vehicle, the relative speed of the tailgater relative to the subject vehicle, any signaling actions that were taken, and optionally the bearing and/or GPS coordinates, as well as other parameters which may be useful to authorities and/or insurance companies in event of a collision. The anti-tailgating system may include a wireless transmitter configured to transmit messages such as help request messages to local authorities. The wireless transmitter can also send the event data or a hash-code thereof in real-time, optionally using the internet, to an external storage or processing medium such as a cloud-based storage medium for example. The distinctive signaling devices may include a message projector that conveys a message such as a text message or a numerical message indicating, for example, the time separation between vehicles in seconds, or an acoustical alarm which may emit a tone or message or other distinctive signal to the tailgater.

The anti-tailgating system may include non-transient computer-readable media containing a plurality of predetermined threshold values and a set of instructions that when executed by the processor cause a method to be carried out, the method comprising measuring the separation distance, optionally revising or adjusting the plurality of threshold values based at least in part on current parameters, and activating the distinctive signaling devices when the separation distance is less than a particular one of the plurality of threshold values. The threshold values may be set dynamically, for example by setting each threshold value as a predetermined factor times the speed of the subject vehicle or the tailgating vehicle. Alternatively, the processor may be configured to adjust the threshold values according to the difference in speeds of the subject and tailgating vehicle, for example activating the distinctive signaling devices if the distance between vehicles is shrinking or is below a particular value, and deactivating or downgrading the distinctive signal if the distance between vehicles is increasing or is above a particular value. The method may include calculating the speed difference between the subject and tailgating vehicle and triggering one or more distinctive signals as the speed difference exceeds one of the plurality of threshold values. The method may include calculating the “time separation” between the subject and tailgating vehicles, which equals the separation distance divided by a vehicle speed, wherein the vehicle speed may be the subject vehicle's speed or the tailgating vehicle's speed or an average or other combination of the two. The processor may compare that time separation to the plurality of predetermined threshold values and thereby determine which of the signaling devices to activate. The method may include calculating a time-to-collision and triggering one or more distinctive signals as the time-to-collision shrinks below a particular one of the plurality of predetermined threshold values. Additionally, the threshold values may include adjustments for road conditions, such as doubling each threshold value if the road is wet. The method may include inhibiting the distinctive signal when the subject vehicle speed is below a predetermined value, such as in a traffic jam or when stopped at a traffic light for example. The method may include inhibiting all warning signals if the subject vehicle is towing a trailer for example. The method may include increasing the rate of modulation, or the intensity of the signaling devices, or other parameter successively at successive predetermined time intervals as long as the tailgater fails to increase the separation distance.

The anti-tailgating system may further include an indicator configured to inform the subject vehicle driver of the presence of the tailgater, and/or of the types of distinctive signaling that are activated at any time, and/or other information about the tailgater such as the distance between vehicles and/or the time separation between the vehicles and/or the rate of closure of the tailgating vehicle.

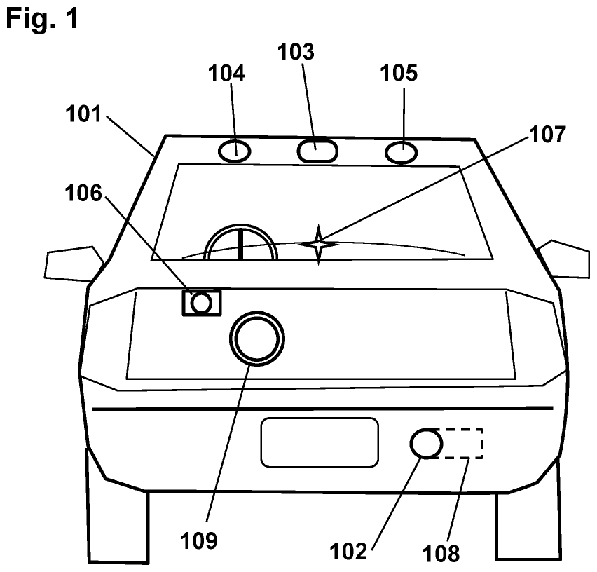

FIG. 1 is a sketch showing a subject vehicle 101 from the rear, including an exemplary anti-tailgating system according to the disclosure. The subject vehicle 101 may include a proximity sensor 102, a processor 108, a camera 106, and signaling devices comprising a first distinctive light 103, a second distinctive light 104, and a third distinctive light 105. The processor 108 may be included in or mounted with the proximity sensor 102 as shown, since the proximity sensor 102 is likely to be the most compute-intensive element in the system. Alternatively, the processor 108 may be elsewhere, for example comprising a central processor for the entire vehicle 101. Also shown is a sonic transmitter 109, such as a speaker to transmit acoustical messages or alarms toward the tailgater.

In some embodiments, the processor 108 may be configured to detect the presence of a second vehicle behind the subject vehicle 101, and to measure the separation distance from the subject vehicle 101 to the second vehicle periodically, and to determine whether the second vehicle is tailgating by comparing the separation distance to the predetermined threshold values. The processor 108 may then initiate and manage various responses according to the separation distance passing (becoming smaller than) each of the plurality of predetermined threshold values. For example, the processor 108 may be configured to compare the separation distance to a plurality of threshold values representing distances between the vehicles, or time separation values, or time-to-collision, or other dynamical parameter associated with the vehicle motions. The processor 108 may be further configured to measure the speed of the subject vehicle 101 and adjust the threshold values accordingly. The processor 108 may be configured to measure environmental parameters such as the road conditions (such as wet or dry, gritty or smooth, flat or sloping etc.) and to further adjust the threshold values.

The processor 108 may be configured to determine the relative speed of the second vehicle (relative to the subject vehicle 101) by differentiating the separation distance versus time for example, and to adjust the distinctive signals and/or the threshold values accordingly. Alternatively, the proximity sensor 102 may be configured to measure the relative velocity using, for example, a Doppler frequency shift or other means. The processor 108 may be configured to reduce the level of distinctive signaling, or to terminate the distinctive signaling altogether, if the tailgater obligingly reduces speed or allows the separation distance to increase. Likewise, the processor 108 may increase the degree or intensity or frequency or other property of the distinctive signaling if the tailgater remains at a close distance or accelerates or otherwise encroaches upon the subject vehicle 101, while maintaining the distinctiveness vis-a-viz other signals potentially emitted by the vehicle. In addition or alternatively, the processor 108 may be configured to calculate the probable stopping distance of the second vehicle depending on the speed and road conditions, and other factors as appropriate, and thereby determine the various threshold values accordingly. The processor may associate particular signaling responses to each of the plurality of predetermined threshold values, such as increasing the intensity of signaling in inclement weather for example.

The processor 108 may be configured to apply different or increasing distinctive signaling responses sequentially, as each predetermined threshold value is crossed (that is, as the separation distance becomes less than each threshold value). For example, the first threshold value may be 20 meters, and if the separation distance becomes less than that first threshold value, then the processor 108 may activate the first distinctive light 103. Preferably, the first distinctive light 103 is visually distinctive (perceptibly different from all other light sources on the rear of the subject vehicle 101) so that the tailgater cannot confuse the first distinctive light 103 with any other lights on the vehicle, such as the turn signals or the brake lights or the running lights, for example. The first distinctive light 103 may have a distinctive color such as violet or yellow or white, so as to not look like a center-mounted brake light. Alternatively, the distinctive light 103 may be configured to alternate in two colors, such as red and white, or red and amber, or yellow and purple, or other visually distinct colors, thereby not being confused with any other lights on the vehicle 101. Alternatively, the distinctive light 103 may be a standard light such as a brake light or a turn signal light or a backup light on the subject vehicle 101, but caused to emit a distinctive color or to be modulated in a distinctive way. If the tailgater then passes a second threshold value, such as 16 meters, the first distinctive light 103 may be increased in some parameter such as modulation, such as to begin flashing in response to the second threshold value being crossed. The flashing may comprise one or more strobe-like flashes of light, wherein a “strobe-like” flash is a light pulse with a sufficiently brief duration that it appears instantaneous, that is, the duration is not perceptible to an average viewer. When the separation distance (or the time separation or other parameter) crosses a third threshold value, such as 12 meters, the second and third distinctive lights 104-105, such as violet spaced-apart lights, may be flashed in alternation. At a fourth threshold value, such as 8 meters, the camera 106 may start taking photos of the tailgater, including the license plate if visible. Preferably, the camera 106 also emits some kind of signal, such as a brief flash of white light to indicate to the tailgater that the tailgater is being documented. Finally, if the separation distance shrinks below a fifth threshold value, such as 4 meters, the processor 102 may send an emergency message to the local police or other authorities alerting them of the hazard and documenting the tailgater, and such automatic transmission may have an optional threshold or condition of a minimum speed of the subject or the tailgating vehicle (and this is true of other embodiments as well)

In some embodiments, the signaling devices such as the distinctive light or lights 103-105 may be configured to direct a distinctive signal only toward the tailgating driver, and to avoid directing the distinctive signal toward any other drivers, thereby avoiding distracting the other drivers and avoiding a misunderstanding or confusion by the other non-tailgating drivers. For example, each distinctive light 103-105 may include a laser and/or a lens and/or a collimator to thereby emit a focused narrow light beam, which may be sized and aimed to encompass the tailgating driver's viewpoint, and to be invisible or nearly invisible to other drivers. The directing or aiming may include redirecting the light beam horizontally to include just the tailgating driver, and/or redirecting the light beam vertically to account for vehicles of different heights. The diameter or opening angle or divergence of the light beam may be adjusted according to the separation distance, for example reducing the divergence of the light beam if the tailgater is farther away, which may keep the visual intensity of the light beam, as viewed by the tailgater, roughly constant regardless of the separation distance. Alternatively, the light beam may be made brighter or more tightly focused when the tailgater gets closer, to increase the urgency of the warning. Alternatively, the light beam may have a divergence such that the perceived intensity automatically increases as the tailgater gets closer. The aiming may include artificial intelligence and/or analysis of images from the rear-facing camera 106 or other sensor to control the direction of the light beam. In this way, the distinctive signal may be configured to be visible only to the tailgating driver, and not to be visible to any other driver in the same lane or in other lanes.

In some embodiments, an indicator 107, such as a lamp on the subject vehicle dashboard or elsewhere, visible to the driver of the subject vehicle 101, may be activated whenever the tailgater is detected, or whenever one of the threshold values is passed, or at other times to indicate to the subject driver that there is a closely-following vehicle. The indicator 107 may also be modulated to indicate which threshold value has been crossed or which distinctive signal has been activated, so that the subject driver can take defensive action, such as temporarily speeding up or by pulling over when safe. The indicator 107 may further include an audio message such as a computer-generated speech stating the distance for example.

In some embodiments, the rear-facing sonic transmitter 109 may be activated when one of the threshold values is passed, and may send an acoustical message, such as a computer-generated speech message to the tailgater requesting more space, or a tone or other alarm as appropriate. In some embodiments, the sonic transmitter 109 may be configured to focus the sound energy narrowly toward the tailgater so as to maximize the effect on the tailgater and avoid being detectable by other drivers.

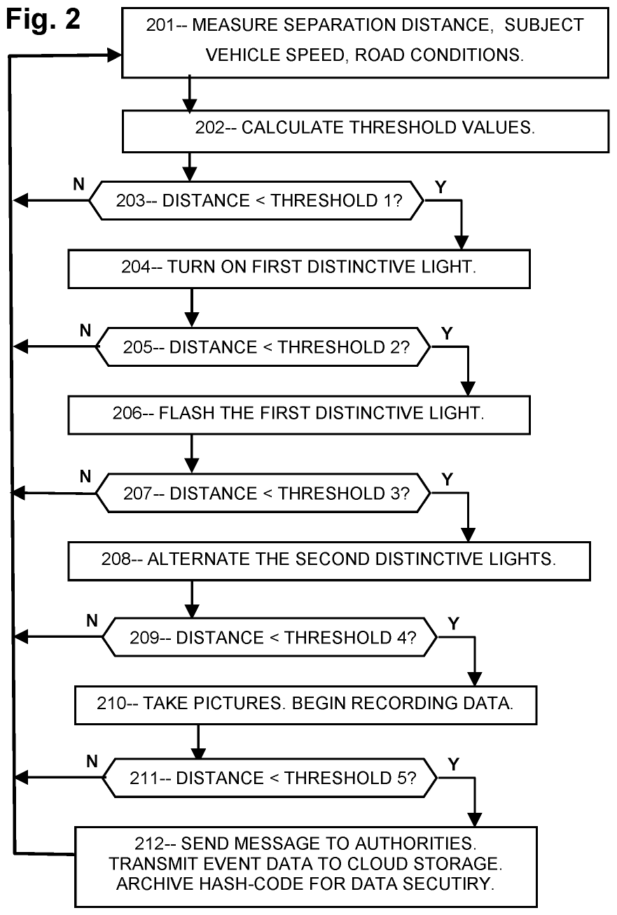

FIG. 2 is a flowchart showing steps of an exemplary method that may be stored on non-transient computer-readable media until executed by the processor 108. First 201 the separation distance of the following vehicle may be measured, and the speed of the subject vehicle may be determined, among other measurements. Then 202 a set of threshold values may be calculated. In addition, in some embodiments, the condition of the road, such as wet or dry, smooth or rough, clean or gravely, flat or sloping, straight or twisty, wide or narrow, with or without shoulders, with or without surrounding traffic, with or without obstructions such as stop signs or traffic lights, and any other conditions related to stopping distances may be determined; and the set of thresholds may be adjusted accordingly. For example, a first threshold value may be adjusted proportional to the speed, such as 1 meter of separation distance per 4 kph of speed (corresponding to 25 meters for a 100 kph freeway speed), and may be doubled to 2 meters per 4 kph if the pavement is wet, or an even higher value if the pavement is icy.

Then 203 if the separation distance is less than a first threshold value, the first distinctive light (having a parameter different from the corresponding parameter of all other signals present at the rear of the subject vehicle, such as a distinctive color or an alternating contrasting color or a shape or spatial configuration or position on the subject vehicle for example) may be turned on 204. Then 205 if the second threshold value is passed, the first distinctive light may be flashed 206 such as red-amber alternating flash. Then 207 if the third threshold value is passed, additional distinctive lights (positioned laterally in this example) may be flashed in alternation 208 such as white-violet lights. Then 209 if a fourth threshold value is passed, a still or video camera may begin recording images 210. The images and other event data, such as the separation distance and relative speed versus time, may be stored in non-volatile memory on-board the subject vehicle. Then 211 if a fifth threshold value is passed, a message such as a wireless message may be sent to authorities 212. In addition, the event data may be transmitted to an external data storage means, which may use the internet for data transfer to distributed third-party storage means. To prevent, or at least detect, corruption of modification of the stored data, a hash-code (a mathematical construct of the raw data values) may be transmitted to an external site.

As a further option, the subject vehicle may include a rear-facing speaker which may play a pre-recorded or computer-generated message such as an emergency-sounding tone or warble, or a computer-generated speech such as “Please back off! I will pull over as soon as it is safe!”. The audio message may be triggered by the fourth or fifth threshold, or a different threshold, or manually by the subject vehicle driver for example.

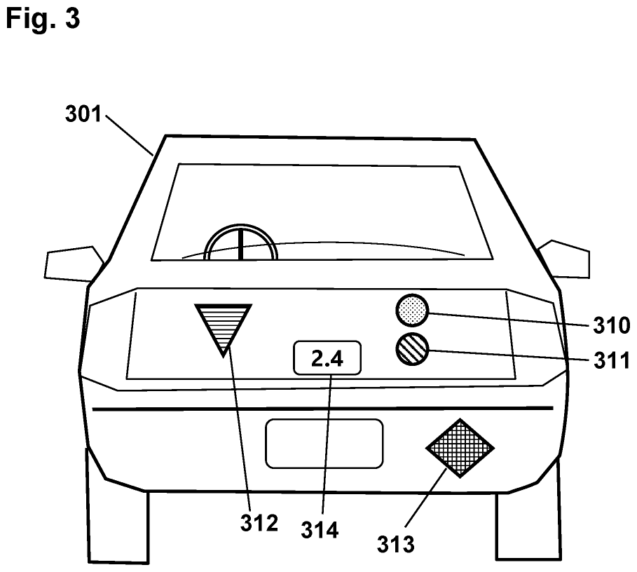

FIG. 3 shows another exemplary embodiment of an anti-tailgating system comprising two distinctive lights 310 and 311 configured to be distinctly associated with tailgating and not confusable with any of the other lights on the vehicle 301. For example, the lights 310 and 311 may be in a vertical alignment, and may be positioned asymmetrically, or off-center, such as midway between the centerline and the brake lights, and may have distinctive colors such as red and amber, or violet and yellow, or red and white, and may be flashed or alternated up and down to produce a distinctive signal to the tailgater.

Also shown is an alternate distinctive light 312 in the shape of a triangle and positioned off-center or asymmetrically on the left side. The distinctive light 312 is thereby not confusable with brake lights, due to its distinctive position and shape, and to the asymmetric position of the light 312 since all other lights normally present on the rear of a vehicle 301 are either on the centerline or are equally distributed on the left and right sides, that is, they are left-right symmetric. Another distinctive light 313 in the shape of a diamond is shown on the bumper of the vehicle 301, also in an asymmetric position to the right side of the centerline. Each of the exemplary distinctive signaling devices 310-313 includes at least two features (such as color, shape, or position) that clearly discriminate it from all other lights commonly found on vehicles.

Alternatively, the distinctive lights 310 or 311 or 312 may be shaped in any way that is visually different from other signals on the subject vehicle 301, such as an annular, or linear, or X-shaped, or diamond-shaped lights, or a cluster of lights arranged in a triangular or annular or linear or X-shaped or diamond-shaped form, or other shape or arrangement of sights configured to produce a visual signal that is different from all other signals present at the rear of the subject vehicle.

Also shown is a numerical display 314 showing the time separation between the subject vehicle and the tailgating vehicle in seconds. The processor may calculate the time separation between vehicles by dividing the separation distance by the speed of the subject and/or tailgating vehicle for example, and cause the numerical display 314 to indicate the separation time using, for example, luminous numerals. The numerals may comprise LEDs such as standard 5×9 LED displays, or other display means for indicating the time separation. In addition, the processor may be configured to change the displayed numerals according to the changing time separation in real-time, thereby indicating to the tailgater how much time separation exists between the vehicles. In addition, the numerical display 314 may be configured to vary a property such as color or modulation of the numerals according to the displayed value or the plurality of predetermined threshold values or other criteria. For example, when the tailgater is at a safe distance corresponding to a 3-second time separation, the numerical display may illuminate “3.0” in green, indicating safety. Then if the tailgater approaches closer and the time separation shrinks to, for example, 2.0 to 2.9 seconds, the numerical display 314 may illuminate in amber or other color. Then if the tailgater approaches closer and the time separation shrinks to, for example, 1.0 to 1.9 seconds, the numerical display 314 may illuminate in red or other color. Then if the tailgater approaches closer and the time separation shrinks to, for example, 0 to 0.9 seconds, the numerical display 314 may flash or pulse in red or other color. Alternatively, the color and modulation changes may be caused according to the passage of particular threshold values of the plurality of predetermined threshold values. In this way the tailgater would learn that the separation distance is safe or is too close, and also whether the separation distance is increasing or decreasing. Responsible drivers know that a 3.0 second time separation is the minimum safe separation between vehicles, and therefore will back off when they see a time separation display showing a shorter time.

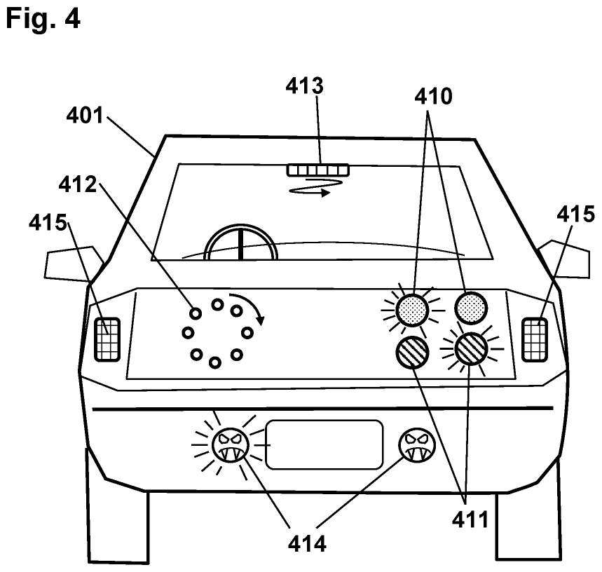

FIG. 4 shows another exemplary embodiment of an anti-tailgating system on a vehicle 401 with distinctive lights 410 and 411 in a rectangular arrangement and an asymmetric position, with one color (such as violet) on the top and another color (such as white) on the bottom to provide a readily understood distinctive signaling message to the tailgater. As mentioned, these lights 410 and 411 may be flashed together, or in up-down alternation, or in left-right alternation, or in diagonal alternation as indicated by “solrads” around certain lights, or in a circular rotation, or otherwise to signal to the tailgater in a clearly distinctive way that the system has detected the tailgater and that the tailgater is too close.

Also shown is an alternative exemplary distinctive signaling device comprising a circular array 412 of small lights such as LED lights, of a distinctive color, and illuminated in a circular rotation as indicated by an arrow.

Also shown is an alternative exemplary distinctive signaling device comprising the standard center-mounted brake light assembly 413, containing a plurality of (usually 4 to 8) LED's or other small lamps, and illuminated in a back-and-forth manner as indicated by a curvy arrow. Alternatively, the center-mounted brake light assembly 413 may be configured to emit a white light when the separation distance is less than one of the threshold values. As a further alternative, the center-mounted brake light assembly 413 may be configured to emit red light and white light in alternation when the tailgater passes one of the threshold values. For example, the center-mounted brake light 413 may include a sufficient number, typically 4 to 8, dual-filament incandescent bulbs configured to emit red or white light when powered alternately, or dual-color LEDs configured with white-emitting and red-emitting when powered with positive versus negative voltage, in some embodiments. In other embodiments, the center-mounted brake light 413 may include two light emitters side-by-side in the assembly, such as alternating red and white LEDs, so that the red or white LEDs can be powered separately to produce a distinctive red-white temporally modulated visual signal.

As a further alternative, the signaling device may comprise the standard corner-mounted brake lights 415 of the subject vehicle, and the processor may be configured to activate the brake lights by flashing them briefly in a strobe-like flash. The brief light pulse from the brake lights 415 may be flashed at intervals, such as once per second, as long as the separation distance is less than a threshold value, thereby signaling to the tailgater to back away.

As a further alternative, the various lights may be activated in an increasing sequence as the separation distance is reduced. As the tailgater passes each threshold value, the number of lights activated may be increased and/or the intensity of signaling may be increased. For example, the center-mounted brake light 413 may be activated when the tailgater passes the first threshold value, then the corner-mounted brake lights 415 may be activated at the second threshold value, then the turn signals at the third threshold, followed by the backup lights at the fourth threshold value. In addition, the various lights and lamps may be flashed in a circular or rotating pattern or in a random or pseudorandom or chaotic fashion, optionally including changing the colors and pulse modulation parameters of each light individually, when the tailgater gets too close, thereby distinctively alerting the tailgater to back off.

Also shown is an alternative exemplary distinctive signaling device comprising two lights 414 positioned on the left and right sides of the license plate respectively, and illuminated in alternation as indicated by solrads.

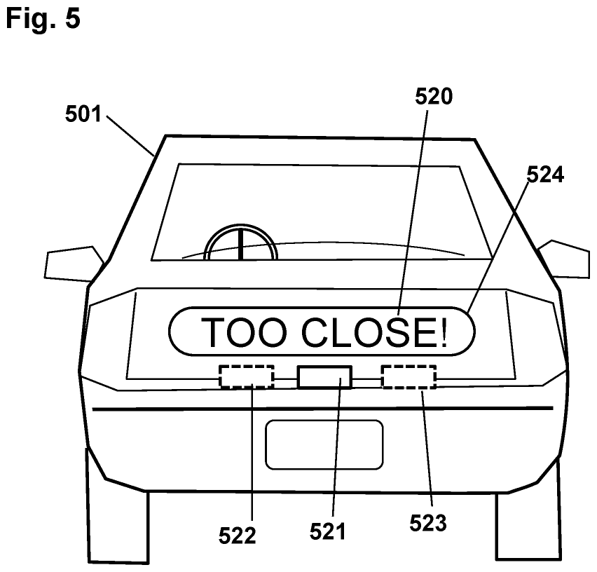

FIG. 5 shows yet another exemplary embodiment of an anti-tailgating system in which a textual message 520 is visibly provided upon the back of the subject vehicle 501, or on a panel or screen 524 mounted rearward on the subject vehicle 501, or on the back window. The message 520 may be static or progressive or flashing or color-changing or otherwise modulated to convey the message and its importance to the tailgater. For example, the message 520 may be displayed as static when a first threshold value is passed, and then the message may be flashed when a second threshold value is surpassed, and then upon a third threshold value it may be flashed alternately red and white, or other distinctive colors, and continuing with increasingly emphatic modulations as the tailgater draws closer to the subject vehicle 501.

The message 520 may be projected onto the back surface, such as the trunk lid or the bumper, of the subject vehicle 501 by a projector 521 such as a vector or raster or a silhouette template or other type of projector configured to form the letters of the message 520 in light. Alternatively, for compactness, a plurality of smaller projectors 521, 522, and 523 may be arranged spaced-apart laterally and configured to each produce a subset of the message 520 respectively. The projector may be configured to project the message, or a part of the message, in such a way as to achieve a desired effect, taking into account the geometry of the portion of the subject vehicle on which the project occurs, e.g., to allow for foreshortening, perspective, and so on.

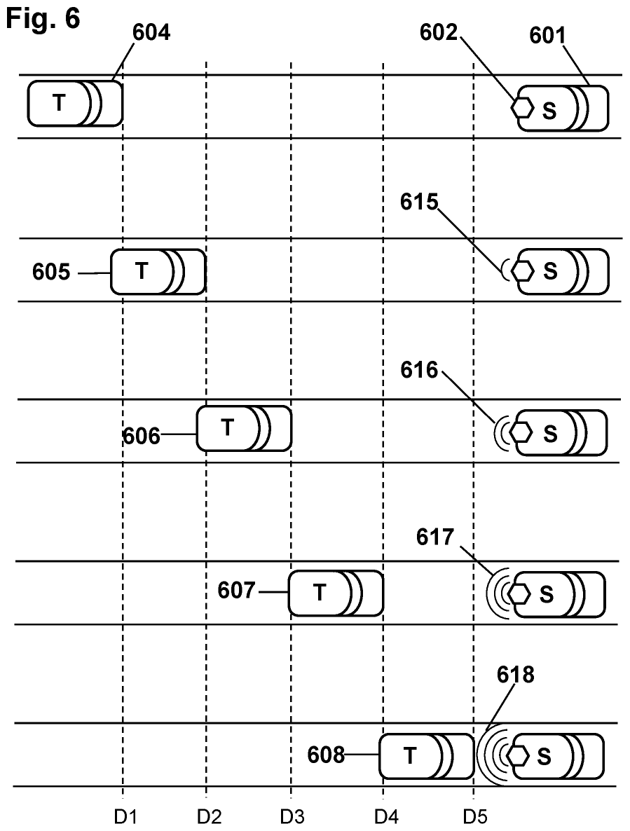

FIG. 6 is a notional sketch of a roadway containing a subject (“S”) vehicle 601 at successive times, and a tailgater (“T”) 604-608 at successive times, all in a coordinate system traveling with the subject vehicle 601. The subject vehicle 601 is shown with an anti-tailgating system 602 configured to emit distinctive signals 615-618 as the tailgater 604-608 crosses each successive distance threshold D1-D5.

First, according to some embodiments, when the tailgater 604 reaches the D1 threshold, the anti-tailgating system 602 may detect the approaching vehicle 604 and monitor it, but without emitting a distinctive signal since there is still plenty of separation distance at D1. Then, when the tailgater 605 reaches D2, the system 602 may emit a first distinctive signal 615, such as a violet or blue or yellow light, which is indicated schematically as waves 615. Then, when the tailgater 606 passes threshold D3, the distinctive signal 616 may be increased, for example by flashing the light. Alternatively, the distinctive signal 615 and/or 616 may comprise a brief strobe-like flash, optionally with a distinctive color, such as white. Since none of the other lights on the rear of a vehicle 101 emit a brief strobe-like flash, the signal 615 or 616 may thereby distinctively indicate that the tailgater is too close. As used herein, a brief strobe-like flash is a pulse of light with a duration sufficiently short that it appears to be instantaneous, that is, with no perceptible duration.

Then, when the tailgater 607 passes D4, the distinctive signal 617 may be further increased by alternately flashing a distinctive color or changing to a red-amber rapid alternation, or to a red-white rapid alternation, or otherwise conveying to the tailgater 607 in a distinctive way that the separation distance is too short for safety. For example, if the distinctive signal 615 includes a brief strobe-like flash, the further increased signal 617 may comprise a series of brief strobe-like flashes in rapid sequence, such as three brief strobe-like flashes in rapid succession followed by a pause, or other distinctive pattern different from the light patterns commonly observed on a vehicle 601.

Then, if the tailgater 608 exceeds D5, the distinctive signal 618 may be further upgraded, for example by emitting brief strobe-like flashes continuously, or emitting the brief strobe-like flashes in two alternating colors such as red and white, or sounding an acoustical alarm, or emitting a computer-generated speech message. The system may also transmit a message to local authorities. Also, at threshold D3 or D4 or D5, a camera may begin documenting the action. Preferably, the measured distance and velocities may be recorded along with the images and stored in a non-transient memory, and/or transmitted elsewhere, to further document the action.

As a further alternative, the processor may be configured to wait, after the tailgater passes each threshold value, for a predetermined waiting interval before activating the signaling devices if the tailgater is still in breach of the threshold value. In some cases the tailgater may recognize the hazard and move farther back without the need for signaling. In that case, the processor may activate the signaling devices only after waiting for the delay time after each threshold value is passed, and then activate the associated signal if needed.

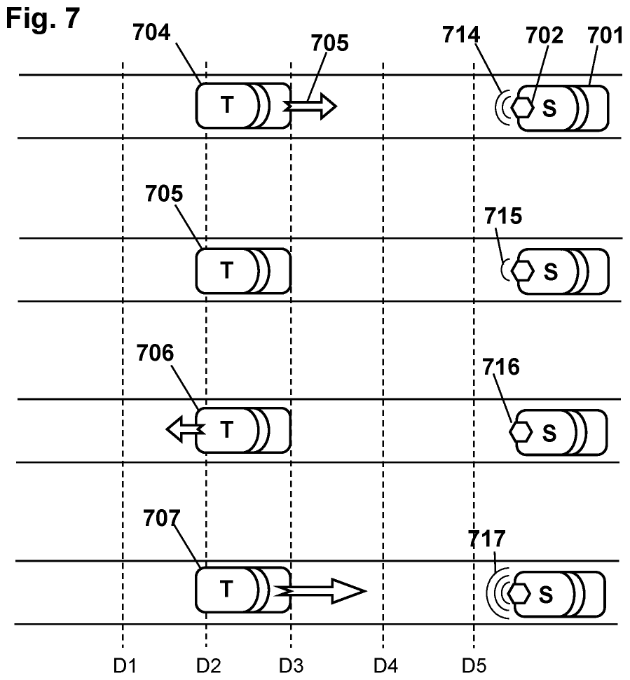

FIG. 7 is a notional sketch showing several versions of a roadway with a subject vehicle 701 containing an anti-tailgating system 702. A tailgater 704-707 is shown at the same separation distance D3 in each case. The distinctive signaling 714-717 may be modulated according to the relative speed of the tailgater 704-707 as indicated by an arrow 705, where the relative speed is the difference between the speed of the subject vehicle 701 and the tailgater 704.

First, the tailgater 704 is approaching the subject vehicle 701 as indicated by the relative velocity arrow 705 which indicates the velocity of the tailgater 704 relative to the subject vehicle 701. The anti-tailgating system 702 may analyze the separation distance, the relative velocity, and other conditions, and thereby select a suitable response which may be to emit a distinctive signal 714 warning the tailgater 704 to reduce speed.

Then, if the tailgater 705 subsequently cooperates by reducing the tailgater vehicle speed to match that of the subject vehicle 701, the distinctive signal 715 may be reduced or extinguished, thereby rewarding the tailgater 705 for slowing down and not approaching closer. For example, the initial distinctive signal 714 may comprise a flashing light, while the reduced distinctive signal 715 may be a non-flashing light, which indicates that the tailgater 705 has partially complied by slowing down but is still too close.

Then, if the tailgater 706 slows down further to allow more space to open up between vehicles, the anti-tailgating system 716 may cease distinctive signaling entirely, as a further reward for compliance and safe driving.

If, on the other hand, the tailgater 707 speeds up while already too close, then an increased distinctive signal 717 may be generated, corresponding to a higher threshold (such as D4 or D5) than the current position (D3) of the tailgater 707. The higher threshold thereby accounts for the increased relative velocity of the tailgater, the rapid closing rate, and its attendant hazards.

The processor may thus calculate a level of hazard presented by a tailgater, including for example the separation distance, the speed, the relative speed, the road conditions, and optionally surrounding traffic conditions and other conditions, thereby calculating an overall hazard level associated with the tailgater. The processor may then cause the distinctive signaling devices to emit distinctive signals according to the calculated level of hazard. The processor may use a formula to calculate the level of hazard, which may include a time-to-collision. The formula may then provide as output a numerical level of hazard, from which the processor can select the appropriate distinctive signaling device or devices that are to be activated. That formula may include the time-to-collision if the tailgater remains on-course. The formula may include a likelihood that a collision would occur if the subject vehicle has to stop suddenly, or other criteria. The formula may be derived by artificial intelligence, or empirical statistical experience, or other suitable way of creating the formula, so long as the formula can determine which distinctive signaling is appropriate for the immediate tailgating situation.

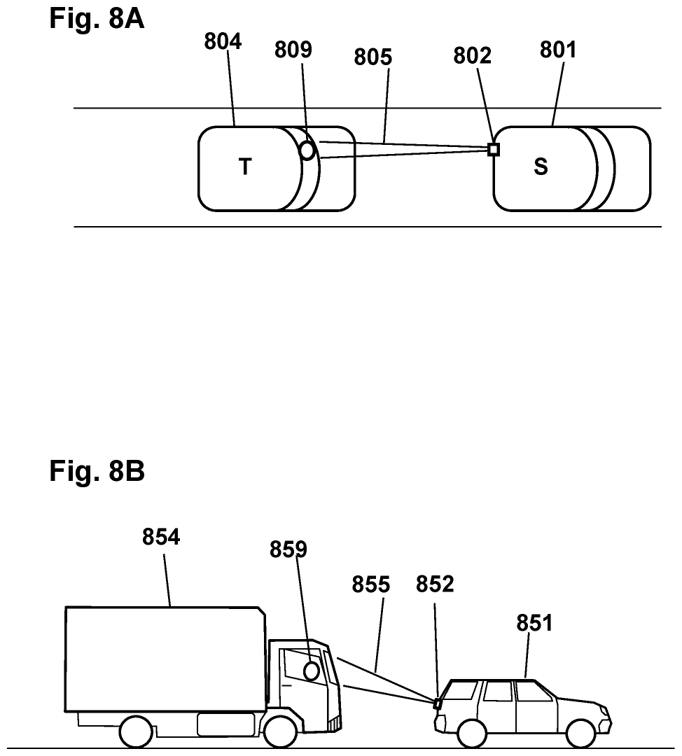

FIG. 8A is a notional sketch showing a tailgating driver 809 in a tailgating vehicle 804 following a subject vehicle 801 that contains an anti-tailgating system comprising a lamp 802 emitting a distinctive light beam 805 focused and aimed at the tailgating driver 809. The lamp 802 may be positioned toward the left side of the subject vehicle 801 as shown, and may be directed rearward so as to signal the tailgating driver 809 while avoiding signaling toward any other drivers (to avoid deleterious distraction, and so on). Alternatively, the lamp 802 may be configured to adjust the direction of the light beam 805 according to the lateral position of the tailgating vehicle 804 in real-time, thereby keeping the light beam 805 directed at the tailgating driver 809 and only the tailgating driver 809, even as the tailgating vehicle 804 moves left and right, or around curves, etc. The light beam 805 may thereby be adjusted and aimed so as to avoid, or greatly minimize, other drivers being able to see the light beam 805. The focus or divergence of the light beam 805 may be adjusted to include the tailgater while avoiding other drivers. Preferably, the intensity of the light beam 805 may be adjusted according to the ambient light, being made brighter in noon sunshine and dimmer at night, to avoid distracting or flash-blinding the tailgating driver 809. The intent is only to signal, not to punish or threaten the tailgater 809.

FIG. 8B is a sketch showing a tailgating vehicle 854, in this case a truck, following a subject vehicle 851 which has an anti-tailgating system comprising a lamp 852 emitting a distinctive light beam 855 toward the tailgating driver 859. To account for different vehicle heights, the lamp 852 may be configured to direct the distinctive light beam 855 upward or downward at an angle corresponding to the vertical position of the tailgating driver 859. Image analysis may be used to control the direction of the distinctive light beam 855. The lamp 852 may include an articulated mirror or other optical element to control the aim of the distinctive light beam 855, or the lamp 852 may itself be rotatable using a hinge or gimbal, for example.

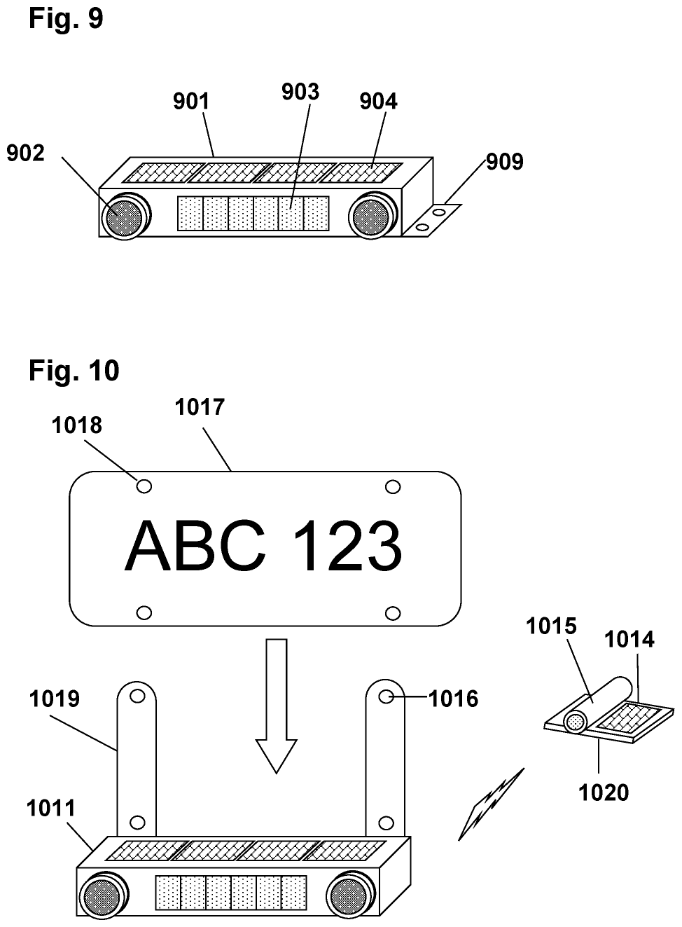

FIG. 9 shows an exemplary embodiment of a user-installable after-market anti-tailgating system 901. In one version, the system 901 may be mountable inside the subject vehicle adjacent to the rear window. The system 901 may include a proximity sensor comprising two spaced-apart rear-facing cameras 902 configured to record images of the tailgating vehicle and to determine the separation distance according to differences between the two images. The cameras 902 may be further configured to measure the speed of the subject vehicle by analysis of the images. The system 901 may include a distinctive signaling means, such as an array of distinctive lights 903 configured to emit a focused beam through the rear window and upon the tailgater only. The system 901 may include solar panels 904 to power the system 901, and to recharge batteries mounted inside the system 901. A drilled tab 909 or other fastening means may be provided to secure the system 901 to the back window ledge, or alternatively, a clamp and bracket may be provided to secure the system 901 to the ceiling behind the rear window, or otherwise to secure the system 901 so that it has good visibility of encroaching traffic.

FIG. 10 shows an exemplary embodiment of a user-installable, exterior-mounted anti-tailgating system 1011. The exterior-mounted system 1011 may be similar to the interior-mounted unit 901 of FIG. 9, but preferably made weathertight. In addition, mounting means may be provided so that the system 1011 may be mounted on the rear exterior surface of the subject vehicle. For example, the system 1011 may include metal brackets 1019 having punched holes 1016 that match the mounting holes 1018 of the license plate 1017. To attach the system 1011, the user can remove the license plate 1017, then position the license plate 1017 over the system 1011 so that the bracket 1019 holes 1016 are in alignment with the license plate 1017 holes 1018, then attach both the system 1011 and the license plate 1017 together using the license plate bolts. Alternatively, a mounting tab such as 909 may be provided so that the user can mount the system 1011 onto the top of a plastic bumper, for example.

Also shown is a dashboard-mounted indicator lamp 1015 configured to communicate wirelessly with the exterior-mounted system 1011 and to illuminate the lamp 1015 whenever a tailgater is detected. The lamp 1015 may include an adhesive pad 1020 or other mounting means to secure the lamp 1015 to the dashboard. The lamp 1015 may also include a photocell 1014 to power the lamp 1015. In some embodiments, the system 1011 may further include an anti-theft feature in which it stops working if it is unable to detect the dashboard-mounted indicator lamp 1015.

In other after-market embodiments, the system 901 or 1011 may be installable by a professional shop rather than by the end user. For example, holes may be drilled through the rear bumper, or the trunk lid, or elsewhere on the rear of the subject vehicle to accommodate proximity sensor means, distinctive signaling means, and mounting bolts and the like. The professionally mounted system may be powered from the vehicle accessory power, by tapping into the appropriate cables, as is well known in the art.

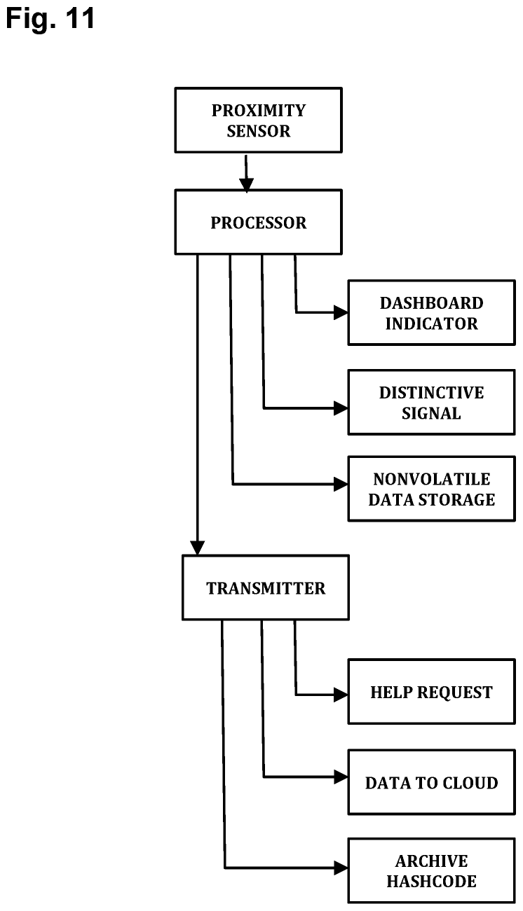

FIG. 11 is a schematic of an exemplary anti-tailgating system showing certain components and how information flows between the components during a tailgating event. First the proximity sensor detects an approaching vehicle from behind and sends data to the processor, which analyzes the data along with the subject vehicle speed and other conditions, compares the results to predetermined thresholds, and applies increasing levels of response. For example, the processor can illuminate a dashboard indicator so that the subject driver is warned of the tailgating situation. As the tailgater approaches closer, the processor may activate the distinctive signal, and may increase the type of distinctive signal in stages. When a particular threshold is passed, the processor may begin storing event data, such as proximity and speed data and images, to a nonvolatile data storage means, which is preferably hardened against destruction even in a violent collision.

After another threshold is passed, the processor may activate the transmitter to send a message, such as a help request message, to authorities. The transmitter may be configured to copy the event data to a remote storage means such as the “cloud” or a dedicated server or other data storage means. As a further guard against the event data being erased or tampered with, a hash-code of the event data may be transmitted to a storage medium elsewhere.

If a collision occurs during a tailgating event. the stored data may be protected from loss or tampering by setting a write-protect feature of the data storage medium. Subsequently, insurance companies and other authorities may access the data to perform accident analysis and other purposes.

The problem of dangerous tailgating is a common problem worldwide, and is entirely unsolved with current vehicle technology. Embodiments of anti-tailgating systems disclosed herein are intended to reduce the incidence of dangerous tailgating by warning the tailgater using distinctive signaling devices, such as flashing lights, and by escalating the warning if the tailgater moves even closer, according to a plurality of predetermined threshold values. While some heedless drivers may ignore these warnings, many others are likely to respond by allowing space to open between vehicles. In addition, versions of the disclosed systems may simultaneously warn the subject driver of the problem, and this may thereby reassure the tailgater that the subject driver is aware of the tailgater. If the tailgater knows that the subject driver will pull over at the next safe opportunity, the tailgater may then back off. Finally, if all warnings fail, versions of the disclosed system can request help and possibly initiate legal action by recording the license plate (if present) and image of the tailgater, and convey that information to the authorities.

Embodiments of the disclosed system can provide numerous advantages not available heretofore. Embodiments can, at extremely low cost, provide: (a) deterrence to most tailgaters by simply activating the warning lights; (b) reassurance to the tailgater that the subject driver is aware of the problem and will allow the tailgater to pass when safe; (c) deterrence to the more aggressive tailgaters by demonstrating that they are being photographed; and (d) a substantial contribution to the prosecution of the worst offenders by providing detailed data directly to the authorities and/or insurance companies. In this way, embodiments of the system can help promote defensive driving and save lives on the highways.

The system and method may be fully implemented in any number of computing devices. Typically, instructions are laid out on computer readable media, generally non-transitory, and these instructions are sufficient to allow a processor in the computing device to implement the method of the invention. The computer readable medium may be a hard drive or solid state storage having instructions that, when run, are loaded into random access memory. Inputs to the application, e.g., from the plurality of users or from any one user, may be by any number of appropriate computer input devices. For example, users may employ vehicular controls, as well as a keyboard, mouse, touchscreen, joystick, trackpad, other pointing device, or any other such computer input device to input data relevant to the calculations. Data may also be input by way of one or more sensors on the vehicle, an inserted memory chip, hard drive, flash drives, flash memory, optical media, magnetic media, or any other type of file-storing medium. The outputs may be delivered to a user by way of signals transmitted to vehicle steering and throttle controls, a video graphics card or integrated graphics chipset coupled to a display that may be seen by a user. Given this teaching, any number of other tangible outputs will also be understood to be contemplated by the invention. For example, outputs may be stored on a memory chip, hard drive, flash drives, flash memory, optical media, magnetic media, or any other type of output. It should also be noted that the invention may be implemented on any number of different types of computing devices, e.g., embedded systems and processors, personal computers, laptop computers, notebook computers, net book computers, handheld computers, personal digital assistants, mobile phones, smart phones, tablet computers, and also on devices specifically designed for these purpose. In one implementation, a user of a smart phone or wi-fi-connected device downloads a copy of the application to their device from a server using a wireless Internet connection. An appropriate authentication procedure and secure transaction process may provide for payment to be made to the seller. The application may download over the mobile connection, or over the WiFi or other wireless network connection. The application may then be run by the user. Such a networked system may provide a suitable computing environment for an implementation in which a plurality of users provide separate inputs to the system and method. In the below system where vehicle controls are contemplated, the plural inputs may allow plural users to input relevant data at the same time.

The embodiments and examples provided herein illustrate the principles of the invention and its practical application, thereby enabling one of ordinary skill in the art to best utilize the invention. Many other variations and modifications and other uses will become apparent to those skilled in the art, without departing from the scope of the invention, which is defined by the appended claims.

1. (canceled)

2. The system of claim 12, wherein the signals are described by parameters that are different from corresponding parameters of all other signals on the subject vehicle.

3. The system of claim 2, wherein the parameters are selected from a list consisting of: color, shape, position, and temporal modulation.

4. The anti-tailgating system of claim 2, wherein the signaling devices include a plurality of lights arranged in configuration selected from a group consisting of a: triangular, annular, linear, X-shaped, and diamond-shaped cluster.

5. The anti-tailgating system of claim 2, wherein the signals include a luminous number displayed on the subject vehicle, the number indicating, in seconds, the separation distance divided by the speed of the subject vehicle.

6. The anti-tailgating system of claim 2, wherein the processor is configured to increase a rate or intensity of the signals at predetermined times or according to predetermined thresholds when the tailgater has failed to increase the separation distance.

7. The anti-tailgating system of claim 2, wherein the signaling devices include a horizontally oriented luminous bar mounted centrally in the subject vehicle and aimed rearward, the bar configured to produce red light when the subject vehicle brakes are applied, and to produce a different color of light when the separation distance is below a particular one of the plurality of predetermined threshold values.

8. The anti-tailgating system of claim 7, wherein the different color of light is selected from the list consisting of: unmodulated white light, white light alternating temporally with red light, and white light alternating temporally with amber light.

9. The anti-tailgating system of claim 2, wherein the processor is configured to activate a first number of the signaling devices when the separation distance is greater than a particular one of the plurality of threshold values, and to activate a second number of the signaling devices, the second number greater than the first, when the separation distance is less than the particular one of the plurality of threshold values.

10. The anti-tailgating system of claim 2, wherein the processor is configured to temporally vary one of a color or a position or a modulation of the signals in a random or pseudorandom fashion.

11. The anti-tailgating system of claim 12, wherein the signaling devices comprise the brake lights of the subject vehicle, and wherein activating the signaling devices comprises causing the brake lights to emit a strobe-like flash or a plurality of strobe-like flashes.

12. An anti-tailgating system to deter tailgating, comprising:
a proximity sensor mounted on a subject vehicle and configured to measure the separation distance between the subject vehicle and a tailgating vehicle;
one or more signaling devices mounted on the subject vehicle and configured to emit signals observable to a driver of the tailgating vehicle; and
a processor configured to compare the separation distance to each of a plurality of predetermined threshold values, and to activate the signaling devices according to which of the predetermined threshold values has been crossed,
wherein the processor is configured to wait for a predetermined waiting interval that begins when the tailgating vehicle passes a particular one of the plurality of predetermined threshold values, and then to activate the signaling devices after the waiting period.

13. An anti-tailgating system to deter tailgating, comprising:
a proximity sensor mounted on a subject vehicle and configured to measure the separation distance between the subject vehicle and a tailgating vehicle;
one or more signaling devices mounted on the subject vehicle and configured to emit signals observable to a driver of the tailgating vehicle; and
a processor configured to compare the separation distance to each of a plurality of predetermined threshold values, and to activate the signaling devices according to which of the predetermined threshold values has been crossed,
wherein the signaling devices are configured to avoid having the signals being visible to other drivers.

14. The anti-tailgating system of claim 12, wherein the processor is further configured to adjust one or more or all of the plurality of predetermined threshold values according a parameter selected from the group consisting of: the speed of the subject vehicle, the speed of the tailgating vehicle, or the difference in speeds of the subject and tailgating vehicles.

15. An anti-tailgating system to deter tailgating, comprising:
a proximity sensor mounted on a subject vehicle and configured to measure the separation distance between the subject vehicle and a tailgating vehicle;
one or more signaling devices mounted on the subject vehicle and configured to emit signals observable to a driver of the tailgating vehicle; and
a processor configured to compare the separation distance to each of a plurality of predetermined threshold values, and to activate the signaling devices according to which of the predetermined threshold values has been crossed,
further comprising a rear-facing camera mounted on the subject vehicle, wherein the processor is configured to activate the camera when the separation distance is less than a particular one of the plurality of predetermined threshold values, wherein the camera is configured to emit a visible flash of light while acquiring images.

16. (canceled)

17. The anti-tailgating system of claim 12, wherein the processor is configured to record the separation distance to non-transient media when the separation distance becomes less than a particular one of the plurality of predetermined threshold values.

18. The anti-tailgating system of claim 12, further comprising a wireless transmitter, wherein the processor is configured to cause the wireless transmitter to transmit a message when the separation distance becomes less than a particular one of the threshold values.

19. The anti-tailgating system of claim 18, wherein the processor is further configured to transmit event data or a hash-code thereof to a storage medium external to the subject vehicle.

20. A method for warning of tailgating vehicles, comprising:
sensing with a proximity sensor a separation distance between a subject vehicle and the tailgating vehicle;
operating a processor, the processor configured to wait for a predetermined waiting interval that begins when the tailgating vehicle passes a particular one of a plurality of predetermined threshold values, and wherein the processor is further configured to activate one or more signaling devices after the predetermined waiting interval, the signaling devices causing one or more signals to be emitted when the separation distance between the subject vehicle and the tailgating vehicle is calculated to be less than a particular value of one of the plurality of predetermined threshold values,
wherein the one or more signaling devices are mounted on the subject vehicle, and wherein the signaling devices are configured to emit the signals in a direction of the tailgating vehicle.
